(19) United States
(12) Patent Application Publication
(10) Pub. No.: US 2018/0371374 A1
(43) Pub. Date: Dec. 27, 2018

(54) SOLVENT CONTAINING HARD SURFACE CLEANING COMPOSITIONS

(71) Applicant: The Procter & Gamble Company, Cincinnati, OH (US)

(72) Inventors: Adam Simon HAYWARD, Durham (GB); Alan Edward SHERRY, Newport, KY (US)

(21) Appl. No.: 16/013,974

(22) Filed: Jun. 21, 2018

Related U.S. Application Data
(60) Provisional application No. 62/522,815, filed on Jun. 21, 2017.

(30) Foreign Application Priority Data
Aug. 8, 2017 (EP) 17 185 218.9
Apr. 20, 2018 (EP) 18 168 419.2

(51) Int. Cl. C11D 3/39; C11D 3/43; C11D 3/37; C11D 3/04; C11D 3/20; C11D 1/75; C11D 11/00

(52) U.S. Cl. CPC C11D 3/3942; C11D 3/43; C11D 3/3707; C11D 11/0023; C11D 3/042; C11D 3/2075; C11D 1/75; C11D 3/3776

(57) ABSTRACT

The need for a fast acting and broad spectrum antimicrobial composition which does not reduce surface shine and does not leave visible residues on the surface, which is also preferably suitable for surfaces which contact food, is met by formulating the hard surface cleaning compositions described herein.

### FIELD OF THE INVENTION

Peroxide-based hard surface cleaning compositions which provide improved shine.

### BACKGROUND OF THE INVENTION

Surfaces which are regularly contacted by organic matter, such as foodstuff, oils, sebum from skin contact, are often prone to contamination by microbes. Such surfaces are often treated or cleaned using antimicrobial compositions, to reduce or eliminate such microbes. To provide meaningful antimicrobial benefits, these antimicrobial compositions are ideally fast acting and ideally have broad spectrum activity. That is, efficacy over a broad range of microbes. In order to achieve fast acting, broad efficacy, antimicrobial compositions typically comprise high levels of antimicrobial actives. As such, they typically leave a residue which reduces surface shine and can give the impression that the surface has not been well cleaned. In addition, such compositions are often less suitable for use on surfaces that are in contact with food.

Therefore, a need remains for a fast acting and broad spectrum antimicrobial composition which does not reduce surface shine and does not leave visible residues on the surface, while also preferably being suitable for surfaces which contact food.

U.S. Pat. No. 8,648,027 B relates to a cleaning composition for sanitizing and/or disinfecting hard surfaces, comprising: a cationic biocide, surfactant and low levels of VOC solvents. GB2318585 A relates to an aqueous based cleaning compositions which include one or more quaternary amine compounds as disinfecting active agents, an organic solvent system which includes glycol mono-n-butyl ether or a binary system including a glycol ether with a linear primary alcohol, and either one or more betaines, or one or more amine oxides as a surfactant constituent. EP 0691397 A relates to an aqueous, antimicrobial hard surface cleaner comprising: a C₁₋₆ alkanol or C₃₋₂₄ alkylene glycol ether; surfactant selected from amphoteric, nonionic surfactants, and mixtures thereof; quaternary ammonium surfactant; builder; and water. GB 2353044 B relates to aqueous based cleaning compositions which comprise a quaternary ammonium surfactant compound having germicidal properties; an amine oxide, a surfactant selected from carboxylates and N-acyl amino acid surfactants; a glycol ether solvent; an alcohol, an alkalizing agent such as an alkylamine; and water. U.S. Pat. No. 6,699,825 B relates to antimicrobial formulations based on organocarboxylic acid, anionic surfactant and a sparingly soluble monohydric solvent. U.S. Pat. No. 7,148,187 B relates to antimicrobial formulations based on lactic acid, anionic surfactant, a food-safe nonionic surfactant and a volatile solvent that is miscible with water. AU 2008239509 B describes compositions based on hydrogen peroxide, lactic acid, anionic surfactant, nonionic surfactant and optionally glycol ether solvents. GB 2319179 A relates to a ready to use acidic aqueous cleaning and disinfecting composition which comprises: 0.1-20% wt. of a C1-C6 monohydric alcohol; 1.0-10% wt. of a glycol ether or butoxypropanol or propoxypropanol; 0.1-12% wt. of a nonionic surfactant; 0.1-1.5% wt. of peroxy compound; 0.1-7% wt. of citric acid. WO 99/35227 A relates to aqueous detergent compositions, preferably hard surface cleaning compositions, which contain alkyl aryl sulfonate surfactant, selected hydrophobic cleaning solvent, polycarboxylic acid, and aqueous solvent system in solution and/or a micellar phase, the pH being from about 2 to about 4. WO 99/27066 relates to aqueous detergent compositions, preferably hard surface cleaning compositions, which contain a flexible lamellar sheet phase dispersed in the aqueous phase. US 2008/251105 A relates to cleaning compositions and cleaning systems comprising an anionic surfactant, a nonionic surfactant, lactic acid, hydrogen peroxide and water. EP 3101105 A1 relates to stabilized hydrogen peroxide-containing compositions and methods of making same, wherein the stabilizer system made up of a disulfonate surfactant, a diester solvent, and a sulfonic acid or a salt thereof in a sufficient quantity to provide the stabilized hydrogen peroxide with an acidic pH value. EP 0829532 A relates to the bleaching of fabrics with liquid compositions comprising a peroxygen bleach and a solvent system comprising a hydrophilic solvent and a hydrophobic solvent. U.S. Pat. No. 6,444,636 B relates to an antibacterial liquid dish cleaning composition comprising an alkyl sulfate, a sulfonate surfactant, a solubilizer, a proton donating agent, polyethylene glycol, hydrogen peroxide, a magnesium inorganic salt and water. EP 0908512 A relates to a liquid aqueous composition having a viscosity of 1 cps to 100 cps when measured with a Brookfield viscometer at spindle 2, rpm 30 and 20° C., and comprising a peroxygen bleach, from 0.001% to 30% by weight of an ethoxylated nonionic surfactant, from 0.001% to 20% by weight of a zwitterionic betaine surfactant and a viscosity controlling agent.

### SUMMARY OF THE INVENTION

The present invention relates to a hard surface cleaning composition comprising: a detersive surfactant; an active oxygen source; a glycol solvent, wherein the glycol solvent is selected from the group consisting of C₁-C₆ diols and triols, and mixtures thereof, preferably propylene glycol, dipropylene glycol, glycerin, 1,3 butylene glycol, ethylene glycol, diethylene glycol, triethylene glycol and mixtures thereof, more preferably propylene glycol; water; and said composition has a pH from 1.0 to 6.0.

The present invention further relates to a method for cleaning a hard surface, comprising the steps of: optionally diluting the hard surface cleaning composition; applying the hard surface cleaning composition to a hard surface; leaving the hard surface to dry without rinsing the surface. The present invention further relates to the use of a glycol solvent in a peroxide-containing antimicrobial composition to reduce surface streaks and/or improve surface shine.

### DETAILED DESCRIPTION OF THE INVENTION

Hard surface cleaning compositions of the present invention, comprising a detergent surfactant, an active oxygen source, and a glycol provide improved surface shine.

The glycol solvents have been found to provide shine improvements by changing the physical pattern of composition residues after application to the surface. It is believed that the glycol reduces the size of the crystals formed by the product residues on the surface upon drying to a particle size that is not visible to the naked eye, and which results in less scattering of incident light. As such, the compositions of the present invention reduce surface streaks and/or improve surface shine when treating the surface with the hard surface cleaning composition. They are also typically suitable for use on surfaces which contact food. Furthermore, such glycols can provide additional benefits alongside shine improvements, such as grease cleaning.

As defined herein, “essentially free of” a component means that no amount of that component is deliberately incorporated into the respective premix, or composition. Preferably, “essentially free of” a component means that no amount of that component is present in the respective premix, or composition.

As defined herein, “stable” means that no visible phase separation is observed for a premix kept at 25° C. for a period of at least two weeks, or at least four weeks, or greater than a month or greater than four months.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

Liquid Hard Surface Cleaning Compositions:

By “liquid hard surface cleaning composition”, it is meant herein a liquid composition for cleaning hard surfaces found in households, especially domestic households. Surfaces to be cleaned include kitchens and bathrooms, e.g., floors, walls, tiles, windows, cupboards, sinks, showers, shower plastified curtains, wash basins, WCs, fixtures and fittings and the like made of different materials like ceramic, vinyl, no-wax vinyl, linoleum, melamine, glass, steel, kitchen work surfaces, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments.

In a preferred embodiment, the liquid compositions herein are aqueous compositions, comprising at least 10% by weight of water. Therefore, they may comprise from 30% to 99.5% by weight of the total composition of water, preferably from 50% to 98% and more preferably from 80% to 97%.

The compositions of the present invention preferably have a viscosity of from 50 Pa·s to 1200 Pa·s, more preferably 100 Pa·s to 800Pa·s, most preferably 200 Pa·s to 600 Pa·s when measured at 20° C. with a AD1000 Advanced Rheometer from Atlas® shear rate 10 s⁻¹ with a coned spindle of 40mm with a cone angle 2° and a truncation of ±60 μm.

The composition has a pH from 1.0 to 6.0, or from 1.0 to 5.5, or from 1.0 to 5.0, or from 2.5 to 5.0. The compositions disclosed herein may comprise an acidifying agent. The acidifying agent may be present to provide buffering capacity. The acidifying agent may also sequester transition metals, including iron, copper, manganese and the like. The acidifying agent may be chosen to further enhance the antimicrobial activity of the composition. The acidifying agent may be a US EPA/Health Canada registered active or a European notified antimicrobial substance.

Suitable acidifying agents may be selected from the group consisting of: organic acid, inorganic acid, and mixtures thereof. Suitable inorganic acids include phosphoric acid, sulfuric acid, urea-sulfuric acid, hydrochloric acid, sulfamic acid, methyl sulfuric acid, hypochlorous acid, sodium bisulfate (sodium hydrogen sulfate), and the like. Suitable organic acids include polymeric acids comprising at least 3 carboxylic acid groups, C₁-C₁₁ organic acids comprising at least one carboxylic acid group, and organic acids that do not comprise carboxylic acid functional groups (such as imidazole derivatives or phenolic or polyphenolic compounds). Non-limiting examples of polymeric acids include polymers of acrylic acid, methacrylic acid, maleic acid, or itaconic acid or copolymers of acrylic acid, methacrylic acid, maleic acid, itaconic acid, or mixtures thereof. Polymeric acids may be homopolymers or copolymers having a molecular weight of 500 g/mol or greater. The polymeric acid may have a molecular weight ranging from 500 g/mol to about 1,000,000 g/mol, or from 500 g/mol to 100,000 g/mol, or from about 1,000 g/mol to 20,000 g/mol. Copolymers may be random copolymers or block copolymers. In addition to monomer units comprising carboxylic acid groups, the copolymers may also include one or more other monomers, such as styrene, acrylic ester, acrylamide, olefin sulfonate, and olefin acetate.

Non-limiting examples of C₁-C₁₁ organic acids include formic acid, acetic acid, benzoic acid, malonic acid, citric acid, maleic acid, fumaric acid, succinic acid, lactic acid, malic acid, tartaric acid, gluconic acid, glutaric acid, adipic acid, 2-ethyl-1-hexanoic acid, heptanoic acid, octanoic acid, nonanoic acid, undecylenic acid, butane tetracarboxylic acid, and the like. The organic acid may be derived from a renewable, plant-based feedstock and produced using natural processes, such as fermentation; examples include bio-based acetic acid, bio-based citric acid, bio-based lactic acid and bio-based succinic acid, and the like. The organic acid may have food-use pedigree or be Generally Regarded As Safe (GRAS) or a food additive by the US Food & Drug Administration.

The acidifying agent can be selected from the group consisting of: formic acid, acetic acid, benzoic acid, malonic acid, citric acid, maleic acid, fumaric acid, hypochlorous acid, succinic acid, gluconic acid, glutaric acid, lactic acid, 2-ethyl-1-hexanoic acid, octanoic acid, nonanoic acid, peracetic acid, peroctanoic acid, undecylenic acid, and mixtures thereof, or from the group consisting of: benzoic acid, citric acid, lactic acid succinic acid, maleic acid, succinic acid, octanoic acid, and mixtures thereof.

The composition may comprise from 0.01% to 40%, or from 0.03% to 25%, or from 0.5% to 15.0%, or from 1.0% to 8.0%, or from 2.0% to 6.0% by weight of the acidifying agent. An increased concentration of acidifying agent increases the composition's reserve buffering capacity, which reduces pH fluctuation upon dilution. Partial neutralization of the acidifying agent to a pH value just below its pKa (e.g., 0.1 to 0.5 pH units below the acidifying agent's pKa) may also help to reduce pH fluctuation upon dilution. A concentrate may therefore be formulated at an increased pH, which may lead to an improved overall safety profile without compromising in-use (diluted) antimicrobial or cleaning performance

A ready-to-use composition, such as compositions comprised within spray containers, may comprise from 0.01% to 1.0%, or from 0.1% to 0.8%, or from 0.2% to 0.6% by weight of the acidifying agent.

The weight ratio of surfactant to acidifying agent in the composition may be from about 50:1 to about 1:50, or from about 10:1 to about 1:10, or from about 5:1 to about 1:5, or from about 3:1 to about 1:3.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate, K₂CO₃, Na₂CO₃ and alkanolamines (such as monoethanolamine, triethanolamine, aminomethylpropanol, and mixtures thereof).

Typical levels of such bases, when present, are from 0.01% to 5.0% by weight of the total composition, preferably from 0.03% to 3.0% and more preferably from 0.05% to 1.0%.

The present hard surface cleaning compositions have improved transparency, and thus reduced haziness. Preferably, the hard surface cleaning compositions have a % haze of from 0 to 15, more preferably 0 to 7, most preferably 0 to 5.

Detersive Surfactant:

The total amount of surfactant can be from 0.01% to 20%, or from 0.1% to 10%, preferably from 0.15% to 5.0% by weight of the composition of said detersive surfactant. The detersive surfactant can be selected from the group consisting of: anionic surfactant, nonionic surfactant, amphoteric surfactant, and mixtures thereof.

Anionic surfactants are particularly preferred. As such, the hard surface cleaning composition can comprise an anionic surfactant, such as those selected from the group consisting of: an alkyl sulphate, a sulphonic acid or sulphonate surfactant, and mixtures thereof. The hard surface cleaning composition can comprise from 0.01% to 5%, preferably from 0.1% to 4%, and most preferably from 0.15% to 1.0% by weight of the composition of anionic surfactant.

Suitable alkyl sulphates for use herein include water-soluble salts or acids of the formula ROSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphates include C₁₂₋₁₄ alkyl sulphate like EMPICOL® 0298/, EMPICOL® 0298/F or EMPICOL® XLB commercially available from Huntsman By “linear alkyl sulphate” it is meant herein a non-substituted alkyl sulphate wherein the linear alkyl chain comprises from 6 to 16 carbon atoms, preferably from 8 to 14 carbon atoms, and more preferably from 10 to 14 carbon atoms, and wherein this alkyl chain is sulphated at one terminus.

Suitable sulphonated anionic surfactants for use herein are all those commonly known by those skilled in the art. Preferably, the sulphonated anionic surfactants for use herein are selected from the group consisting of: alkyl sulphonates; alkyl aryl sulphonates; naphthalene sulphonates; and mixtures thereof.

Suitable alkyl sulphonates for use herein include water-soluble salts or acids of the formula RSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₁₈ linear or branched saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₂-C₁₆ paraffin sulphonate like Hostapur SAS commercially available from Clariant. Particularly preferred alkyl aryl sulphonates are alkyl benzene sulphonates commercially available under trade name Nansa® available from Huntsman.

By “linear alkyl sulphonate” it is meant herein a non-substituted alkyl sulphonate wherein the alkyl chain comprises from 6 to 18 carbon atoms, preferably from 8 to 16 carbon atoms, and more preferably from 10 to 16 carbon atoms, and wherein this alkyl chain is sulphonated at one terminus.

Suitable alkoxylated sulphonate surfactants for use herein are according to the formula R(A)ₘSO₃M, wherein R is an unsubstituted C₆-C₁₈ alkyl, hydroxyalkyl or alkyl aryl group, having a linear or branched C₆-C₁₈ alkyl component, preferably a C₈-C₁₆ alkyl or hydroxyalkyl, more preferably C₁₂-C₁₆ alkyl or hydroxyalkyl, and A is an ethoxy or propoxy or butoxy unit, and m is greater than zero, typically between 0.5 and 6, more preferably between 0.5 and 3, and M is H or a cation which can be, for example, a metal cation (e.g., sodium, potassium, lithium, calcium, magnesium, etc), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like.

Suitable sulphated or sulphonated anionic surfactant for use herein include alkyl sulphates (AS) preferably C₁₂, C₁₃, C₁₄ and C₁₅ AS, sodium linear alkyl sulphonate (NaLAS), sodium paraffin sulphonate NaPC₁₂₋₁₆S, and mixtures thereof. Preferably the sulphated or sulphonated anionic surfactant is selected from the group consisting of alkyl sulphates (AS) preferably, C₁₂, C₁₃, C₁₄ and C₁₅ AS, sodium linear alkyl sulphonate (NaLAS), sodium paraffin sulphonate NaPC₁₂₋₁₆S and mixtures thereof. Most preferred are alkylbenzene sulfonates, especially C₁₂₋₁₄ alkylbenzene sulfonate.

Typically, the composition herein may comprise from 0.5% to 9.5% by weight of the total composition of said sulphated or sulphonated anionic surfactant, preferably from 1.0% to 5.0%, more preferably from 1.5% to 3.5% and most preferably from 2.0% to 3.0%.

In order to reduce foaming during use, the composition preferably comprises less than 6%, preferably less than 3%, more preferably less than 0.5% by weight of alkyl ether sulphate anionic surfactant.

The hard surface cleaning composition can comprise nonionic surfactant, preferably present at a level of from 0.01% to 10%, or from 0.05% to 4%, preferably from 0.1% to 1.0% by weight of the composition of the composition. Suitable nonionic surfactants can be selected from alkoxylated nonionic surfactants, amine oxide surfactants, and mixtures thereof.

Typically, the hard surface cleaning composition may comprise from 0.01% to 10%, or from 0.05% to 4%, preferably from 0.1% to 1.0% by weight of the composition of alkoxylated nonionic surfactant, particularly ethoxylated nonionic surfactant.

Suitable ethoxylated nonionic surfactants are according to the formula RO-(EO)ₙH, wherein: R is a C₆ to C₁₈, preferably a C₈ to C₁₆, more preferably a C₈ to C₁₂ alkyl chain, or a C₆ to C₂₈ alkyl benzene chain; EO is an ethoxy unit, and wherein n is from 1 to 30, preferably from 1 to 15 and, more preferably from 4 to 12 even more preferably from 5 to 10. Preferred R chains for use herein are the C₈ to C₂₂ alkyl chains. Even more preferred R chains for use herein are the C₉ to C₁₂ alkyl chains. R can be linear or branched alkyl chain. The ethoxylated nonionic surfactant preferably has no other alkoxylation other than ethoxylation.

Suitable ethoxylated nonionic surfactants for use herein are Dobanol® 91-2.5 (HLB=8.1; R is a mixture of C₉ and C₁₁ alkyl chains, n is 2.5), Dobanol® 91-10 (HLB=14.2; R is a mixture of C₉ to C₁₁ alkyl chains, n is 10), Dobanol® 91-12 (HLB=14.5; R is a mixture of C₉ to C₁₁ alkyl chains, n is 12), Greenbentine DE80 (HLB=13.8, 98 wt % C10 linear alkyl chain, n is 8), Marlipal 10-8 (HLB=13.8, R is a C10 linear alkyl chain, n is 8), Lialethl® 11-5 (R is a C₁₁ alkyl chain, n is 5), Isalchem® 11-5 (R is a mixture of linear and branched C₁₁ alkyl chain, n is 5), Lialethl® 11-21 (R is a mixture of linear and branched C₁₁ alkyl chain, n is 21), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Dobanol® 91-5 , Neodol® 11-5, Lialethl® 11-21 Lialethl® 11-5 Isalchem® 11-5 Isalchem® 11-21 Dobanol® 91-8, or Dobanol® 91-10, or Dobanol® 91-12, or mixtures thereof. These Dobanol®/Neodol® surfactants are commercially available from SHELL. These Lutensol® surfactants are commercially available from BASF and these Tergitol® surfactants are commercially available from Dow Chemicals.

More preferably, said ethoxylated nonionic surfactant is selected from the group consisting of: C₉₋₁₁ EO5 alkylethoxylate, C₁₂₋₁₄ EO5 alkylethoxylate, C₁₁ EO5 alkylethoxylate, C₁₂₋₁₄ EO21 alkylethoxylate, C₉₋₁₁ EO8 alkylethoxylate, C10EO8 alkylethoxylate, C₁₂₋₁₄ EO7 alkylethoxylate, and mixtures thereof, most preferably, said ethoxylated nonionic surfactant is selected from the group consisting of: C₁₁ EO5 alkylethoxylate, C₉₋₁₁ EO8 alkylethoxylate, C10EO8 alkylethoxylate, C₁₂₋₁₄ EO7 alkylethoxylate, and mixtures thereof.

The ethoxylated alkoxylated nonionic surfactant is preferably selected from the group consisting of: esterified alkyl alkoxylated surfactant; alkyl ethoxy alkoxy alcohol, wherein the alkoxy part of the molecule is preferably propoxy, or butoxy, or propoxy-butoxy; polyoxyalkylene block copolymers, and mixtures thereof. The ethoxylated alkoxylated nonionic surfactant can be a polyoxyalkylene copolymer. The polyoxyalkylene copolymer can be a block-heteric ethoxylated alkoxylated nonionic surfactant, though block-block surfactants are preferred. Suitable polyoxyalkylene block copolymers include ethylene oxide/propylene oxide block polymers, of formula (III):

(EO)ₓ(PO)_{y}(EO)ₓ, or (PO)ₓ(EO)_{y}(PO)ₓ

wherein EO represents an ethylene oxide unit, PO represents a propylene oxide unit, and x and y are numbers detailing the average number of moles ethylene oxide and propylene oxide in each mole of product. Such materials tend to have higher molecular weights than most non-ionic surfactants, and as such can range between 1000 and 30000 g/mol, although the molecular weight should be above 2200 and preferably below 13000 to be in accordance with the invention. A preferred range for the molecular weight of the polymeric non-ionic surfactant is from 2400 to 11500 Daltons. BASF (Mount Olive, N.J.) manufactures a suitable set of derivatives and markets them under the Pluronic trademarks. Examples of these are Pluronic (trademark) F77, L62 and F88 which have the molecular weight of 6600, 2450 and 11400 g/mol respectively. An especially preferred example of a useful polymeric non-ionic surfactant is Pluronic (trademark) F77.

Other suitable ethoxylated alkoxylated nonionic surfactants are described in Chapter 7 of Surfactant Science and Technology, Third Edition, Wiley Press, ISBN 978-0-471-68024-6.

Suitable amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C₁₂-C₁₄ dimethyl amine oxide, commercially available from Albright & Wilson, C₁₂-C₁₄ amine oxides commercially available under the trade name Genaminox® LA from Clariant or AROMOX® DMC from AKZO Nobel.

If present, the hard surface cleaning composition can comprise from 0.01% to 5.0% by weight of the total composition of said amine oxide surfactant, preferably from 0.1% to 2.0%, more preferably from 0.5% to 1.0%.

Suitable amphoteric surfactants include betaines and sulphobetaines. Suitable betaine and sulfobetaine surfactants are according to the formulae:

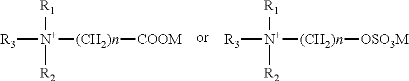

wherein: R₁ and R₂ are each independently linear or branched, saturated or unsaturated hydrocarbon chains of from 1 to 30 carbon atoms, preferably 1 to 20, more preferably 1 to 7 carbon atoms; R₃ is a linear or branched hydrocarbon chain of from 10 to 20 carbon atoms, preferably of from 10 to 18, more preferably 12 to 16 carbon atoms; n is an integer of from 1 to 20, preferably 1 to 10, more preferably 1 to 5; and M is H or an alkali metal, or mixtures thereof.

Suitable betaine surfactant include coconut-dimethyl betaine commercially available under tradename Mackam35® from McIntyre.

The amphoteric surfactant can be present at a level of from 0.01% to 5.0% by weight of the total composition of said composition, preferably from 0.1% to 2.0%, more preferably from 0.5% to 1.0%.

Active Oxygen Source:

In the cleaning compositions according to the invention, the active oxygen source should be present in amounts which are effective in exhibiting satisfactory germicidal activity—against selected bacteria sought to be treated by the cleaning compositions. Such efficacy may be achieved against less resistant bacterial strains with only minor amounts of the active oxygen source being present, while more resistant strains of bacteria require greater amounts of the active oxygen source in order to destroy these more resistant strains.

A germicidally effective amount of the active oxygen source can be considered to result in at least a log 4.5, preferably at least a log 5 reduction of Staphylococcus aureus, using the method of EN1276 (Chemical Disinfectants Bactericidal Activity Testing), in less than 3 minutes.

Suitable active oxygen sources include hydrogen peroxide, peroxyacids, organic peroxides and mixtures thereof. The active oxygen source can be present at a level of from 0.05% to 8%, or from 0.1% to 6%, or 0.2% to 5% by weight of the composition.

The peroxyacid can be preformed, or formed in-situ. For instance, the peroxyacids can be preformed in situ via the reaction of a carboxylic acid-containing acidifying agent and hydrogen peroxide. Suitable carboxylic acid-containing acidifying agent include: formic acid, acetic acid, benzoic acid, malonic acid, citric acid, maleic acid, fumaric acid, hypochlorous acid, succinic acid, gluconic acid, glutaric acid, lactic acid, 2-ethyl-1-hexanoic acid, cinnamic acid, heptanoic acid, octanoic acid, nonanoic acid, peracetic acid, peroctanoic acid, undecylenic acid, and mixtures thereof. For instance, octanoic acid or nonanoic acid can be used to form peroxyoctanoic acid or peroxynonanoic acid, respectively. The rate of formation of the peracid can depend on the pH of the composition (reduced pHs favor peracid formation and faster rates of formation). The weight ratio of hydrogen peroxide to acidifying agent can be from 0.1:1 to 10:1, or from 0.2:1 to 5:1, or from 0.5:1 to 2:1.

The compositions may alternatively comprise hydrogen peroxide and be substantially free of C₆₋₁₂ peracids. Alternatively, the compositions may comprise catalytic amounts of peracid, for instance, from 1 ppm to 50 ppm, or 1 ppm to 10 ppm of the peracid.

The composition may comprise from 0.05% to 8%, or from 0.1% to 6%, or 0.2% to 5% by weight of the composition of hydrogen peroxide.

Compositions comprising hydrogen peroxide should comprise less than 5 ppm transition metal ion impurities, or less than 2 ppm transition metal ion impurities, or less than 0.5 ppm transition metal ion impurities. Compositions comprising hydrogen peroxide may comprise less than 5 ppm ferrous ion, less than 5 ppm ferric ion, or less than 5 ppm of a mixture thereof, or less than 1 ppm ferrous ion, less than 1 ppm ferric ion, or less than 1 ppm of a mixture thereof, or less than 0.1 ppm ferrous ion, less than 0.1 ppm ferric ion, or less than 0.1 ppm of a mixture thereof.

The combination of acid and hydrogen peroxide may generate measurable concentrations of peracid, from the reaction of acid and hydrogen peroxide.

The composition may be substantially free of trace transition metal impurities.

The Glycol Solvent:

The solvents used in this invention are glycol solvents, which are generally liquid at ambient temperature. Said solvents are employed to provide shine improvements to the hard surface cleaning compositions, however said solvents may also be selected to provide secondary benefits in addition to shine, such as improved grease cleaning, formula stability, suds control, or composition viscosity. The glycol solvent is a compound that comprises at least 2 hydroxyl (—OH) groups covalently bonded to one or more carbon atoms within the same molecule. Suitable glycol solvents include germinal diols (two hydroxyl groups on the same carbon atom), vicinal diols (at least two hydroxyl groups are on adjacent carbon atoms), and distant diols (two hydroxyl groups are separated by more than one carbon atom). Examples of geminal diols include dihydroxyacetone, decahydroxy cyclopentane and the like; examples of vicinal diols include propylene glycol, glycerin, 1,2-dihydroxy benzene (catechol) and the like; examples of distant glycols include 1,3-butanediol, 1,3-dihydroxybenzene (resorcinol) and the like. Glycol solvents of use in the invention may be pre-made (e.g., propylene glycol) prior to incorporation into the aqueous compositions of the invention, or may be formed in situ (e.g., dihydroxyacetone) within the compositions of the invention. The glycol solvent can be selected from the group consisting of C₁-C₆ diols and triols. Non-limiting examples of glycol solvents of use in the invention include diethylene glycol, triethylene glycol, dipropylene glycol, and the like. The glycol solvents of use in the invention act as solvents within the compositions in which they are included, but may be liquids or solids at room temperature. The glycol solvent preferably comprises less than 20 carbon atoms, more preferably less than 16 carbon atoms, more preferably less than 12 carbon atoms, and most preferably less than 9 carbon atoms. Propylene glycol is particularly preferred.

The glycol solvent can be present at a level of from 0.01% to 10%, preferably from 0.05% to 5.0%, more preferably from 0.1% to 1.0%, most preferably from 0.2% to 0.5%. The glycol solvent is preferably selected from those solvents that are approved for use in products designed for cleaning or sanitizing food-contact surfaces, as defined by United States Environmental Protection Agency. The solvent may also be chosen to be non-VOC (Volatile Organic Compound), or VOC (e.g. propylene glycol). A VOC solvent may be present at a concentration of less than about 0.5% by weight of the ready-to-use composition.

Without being bound by theory, it is believed that glycol solvents improve the wetting of the hard surface cleaning composition across the surface during application. Consequently, the composition is more effectively dispersed across the surface, resulting in smaller crystal residues upon drying and therefore improved visual shine performance.

Polymer:

The hard surface cleaning composition may comprise a polymer. The polymer can improve grease cleaning, and/or improve the efficacy of the antimicrobial agent. The presence of such polymers has been found to detrimentally affect the surface shine of the treated surface. However, the glycol solvents, as described herein, are particularly effective at promoting the deposition of such polymers as a homogeneous film, thereby reducing their impact on surface shine.

Oxazoline homopolymers and copolymers have been found to be particularly effective at improving the efficacy of antimicrobial agents, particularly residual antimicrobial efficacy. Suitable oxazoline homopolymers can have the formula:

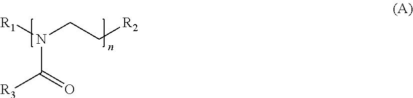

wherein in formula (A):

R₁ is a hydrogen, alkyl, alkenyl, alkoxy, alkylamino, alkynyl, allyl, amino, anilino, aryl, benzyl, carboxyl, arboxyalkyl,carboxyalkenyl, cyano, glycosyl, halo, hydroxyl, oxazolinium mesylate, oxazolinium tosylate, oxazolinium triflate, silyl oxazolinium, phenolic, polyalkoxy, quaternary ammonium, thiol, or thioether group;

R₂ is a hydrogen, alkyl, alkenyl, alkoxy, alkylamino, alkynyl, allyl, amino, anilino, aryl, benzyl, carboxyl, carboxyalkyl, carboxyalkyl, cyano, glycosyl, halo, hydroxyl, oxazolinium mesylate, oxazolinium tosylate, oxazolinium triflate, silyl oxazolinium, phenolic, polyalkoxy, quaternary ammonium, thiol, or thioether group, or a macrocyclic structure;

R₃ is a hydrogen, alkyl, alkenyl, alkoxy, aryl, benzyl, hydroxyalkyl, or perfluoroalkyl group; and

n is in the range of from 1 to 1,000,000.

Suitable oxazoline homopolymers are described in US 2016/0262383 A1.

Suitable oxazoline copolymers can be derived from a monomer mixture comprising monomers having the formulas:

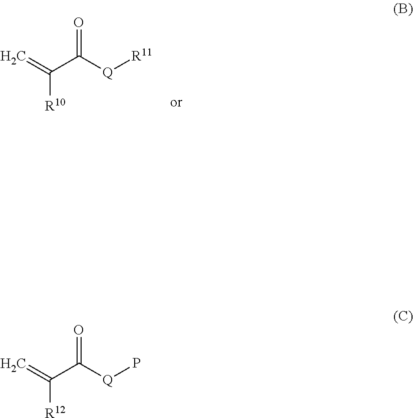

wherein:

Q is O or N;

R¹⁰ is H or CH₃;

R¹¹ is an organic group comprising a hydrolysable silyl group;

R¹² is H or CH₃; and

P is

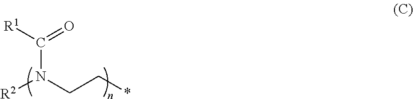

wherein in formula (C):

R¹ is selected from H, an alkyl group, an aryl group, and a combination thereof;

R² is selected from an alkyl group, an aryl group, a combination thereof, and a R^{f}—Y—(CH₂)ₓ group;

R^{f} is a perfluorinated alkyl group;

Y is selected from: —S(O)₂—N(CH₃)—, —S(O)₂—N(CH₂CH₃)—, —S(O)₂—O—, —S(O)₂—, —C(O)—, —C(O)—S—, —C(O)—O—, —C(O)—NH—, —C(O)—N(CH₃)—, —C(O)—N(CH₂CH₃)—, —(CH₂CH₂O)_{y}—, —O—, and —O—C(O)—CH═CH—C(O)—O—;

n is an integer of greater than 2;

x is an integer of at least 2;

y is an integer of at least 1.

Suitable oxazoline copolymers are described in US 2015/0307718 A1.

Other polymers can be used to improve the grease removal performance of the liquid composition due to the specific sudsing/foaming characteristics they provide to the composition, or adhesion prevention. Suitable polymers for use herein are disclosed in EP patent application EP2272942 (09164872.5) and granted European patent EP2025743 (07113156.9). Suitable polymers include: vinylpyrrolidone homopolymer (PVP); polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; and mixtures thereof.

The hard surface cleaning composition may comprise from 0.005% to 5.0% by weight of the total composition of the polymer, preferably from 0.10% to 4.0%, more preferably from 0.1% to 3.0% and most preferably from 0.20% to 2.0%, especially for ready-to-use compositions.

Other Optional Ingredients:

Chelating agent: The hard surface cleaning composition can comprise a chelating agent or crystal growth inhibitor. Suitable chelating agents, in combination with the surfactant system, improve the shine benefit. Chelating agent can be incorporated into the compositions in amounts ranging from 0.05% to 5.0% by weight of the total composition, preferably from 0.1% to 3.0%, more preferably from 0.2% to 2.0% and most preferably from 0.2% to 0.4%.

Suitable phosphonate chelating agents include ethylene diamine tetra methylene phosphonates, and diethylene triamine penta methylene phosphonates (DTPMP), and can be present either in their acid form or as salts.

A preferred biodegradable chelating agent for use herein is ethylene diamine N,N′-disuccinic acid, or alkali metal, or alkaline earth, ammonium or substitutes ammonium salts thereof or mixtures thereof, for instance, as described in U.S. Pat. No. 4,704,233. A more preferred biodegradable chelating agent is L-glutamic acid N,N-diacetic acid (GLDA) commercially available under tradename Dissolvine 47S from Akzo Nobel.

Suitable amino carboxylates include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA), both in their acid form, or in their alkali metal, ammonium, and substituted ammonium salt forms. Particularly suitable amino carboxylate to be used herein is propylene diamine tetracetic acid (PDTA) which is, for instance, commercially available from BASF under the trade name Trilon FS® and methyl glycine di-acetic acid (MGDA). Most preferred aminocarboxylate used herein is diethylene triamine pentaacetate (DTPA) from BASF. Further carboxylate chelating agents for use herein include salicylic acid, aspartic acid, glutamic acid, glycine, malonic acid or mixtures thereof.

Fatty acids are less preferred. If present, the fatty acid is preferably present at low levels of less than 0.5 wt % and can include the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms. Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil. For example coconut fatty acid is commercially available from KLK OLEA under the name PALMERAB1211.

Typically, the hard surface cleaning composition may comprise up to 6.0% by weight of the total composition of said fatty acid, preferably from 0.1% to 3.0%, more preferably from 0.1% to 2.0% and most preferably from 0.15% to 1.5% by weight of the total composition of said fatty acid.

Typically, the hard surface cleaning composition may comprise up to 2.0% by weight of the total composition of said branched fatty alcohol, preferably from 0.10% to 1.0%, more preferably from 0.1% to 0.8% and most preferably from 0.1% to 0.5%.

Further solvent: The liquid compositions of the present invention may comprise solvent or mixtures thereof as a preferred optional ingredient.

Suitable further solvent can be selected from the group consisting of: aliphatic alcohols having from 1 to 6 carbon atoms, ethers and diethers having from 4 to 14 carbon atoms; glycol ether solvents including but not limited to such as ethylene glycol n-hexyl ether, propylene glycol n-butyl ether, and the like; alkoxylated aromatic alcohols; aromatic alcohols; alkoxylated aliphatic alcohols; aliphatic alcohols; C₈-C₁₄ alkyl and cycloalkyl hydrocarbons and halohydrocarbons; terpenes; and mixtures thereof. Ethers such as n-butoxypropanol ether are particularly preferred.

When present, the further solvent can be present at a level of from 0.1 wt % to 10 wt %, or 0.2 wt % to 5 wt %, or 0.5 wt % to 3 wt %.

Essential Oils: Suitable essential oils or actives thereof include those essential oils which exhibit some antimicrobial properties. By “actives of essential oils” it is meant any ingredient of essential oils that exhibits some antimicrobial properties. Essential oils and actives thereof may also provide a desirable odor profile. Suitable essential oils include, but are not limited to, those obtained from thyme, lemongrass, citrus, lemons, oranges, anise, clove, aniseed, cinnamon, geranium, roses, mint, lavender, citronella, eucalyptus, peppermint, camphor, sandalwood, cedar, or mixtures thereof. Actives of essential oils include, but are not limited to, thymol (present, for example, in thyme), eugenol (present, for example, in cinnamon and clove), menthol (present, for example, in mint), geraniol (present, for example, in geranium and rose), verbenone (present, for example, in vervain), eucalyptol and pinocarvone (present in eucalyptus), cedrol (present, for example, in cedar), anethol (present, for example, in anise), carvacrol, hinokitiol, berberine, terpineol, limonene, or mixtures thereof. The compositions disclosed herein may comprise thymol. Thymol is commercially available, for example, from Sigma Aldrich.

Further optional ingredients: The hard surface cleaning compositions may comprise a variety of other optional ingredients depending on the technical benefit aimed for and the surface treated. Suitable optional ingredients for use herein include perfume, builders, buffers, hydrotropes, colorants, stabilisers, radical scavengers, abrasives, soil suspenders, brighteners, anti-dusting agents, dispersants, dye transfer inhibitors, pigments, silicones and/or dyes.

Wipe or Pad

The present invention also relates to an article of manufacture comprising said composition, wherein the composition is comprised in a spray dispenser, or in a wipe or pad. The composition can be comprised on a wipe or pad. Such wipes and pads can be suitable for treating hard surfaces, such as found in the household, and the like. Suitable wipes can be fibrous. Suitable fibrous wipes can comprise polymeric fibres, cellulose fibres, and combinations thereof. Suitable cellulose-based wipes include kitchen wipes, and the like. Suitable polymeric fibres include polyethylene, polyester, and the like. Polymeric fibres can be spun-bonded to form the wipe. Methods for preparing thermally bonded fibrous materials are described in U.S. application Ser. No. 08/479,096 (Richards et al.), filed Jul. 3, 1995 (see especially pages 16-20) and U.S. Pat. No. 5,549,589 (Homey et al.), issued Aug. 27, 1996 (see especially Columns 9 to 10). Suitable pads include foams and the like, such as HIPE-derived hydrophilic, polymeric foam. Such foams and methods for their preparation are described in U.S. Pat. No. 5,550,167 (DesMarais), issued Aug. 27, 1996; and commonly assigned U.S. patent application Ser. No. 08/370,695 (Stone et al.), filed Jan. 10, 1995.

Method of Cleaning A Surface:

The hard surface cleaning compositions described herein are particularly suited for cleaning surfaces selected from the group consisting of: ceramic tiles, enamel, stainless steel, Inox®, Formica®, vinyl, no-wax vinyl, linoleum, melamine, glass, plastics and plastified wood, and combinations thereof. The compositions are particularly suited for reducing or removing antimicrobial activity from the surface, and for cleaning especially when a detersive surfactant, especially an anionic detersive surfactant is present.

For general cleaning, especially of floors and counter-tops, the preferred method of cleaning comprises the steps of:
a) optionally diluting the hard surface cleaning composition of the present invention;
b) applying the hard surface cleaning composition to a hard surface;
c) leaving the surface to dry, without wiping or rinsing the surface.

The hard surface cleaning composition may be diluted to a level of from 0.1% to 2.0%, or from 0.3% to 1.5% by volume. The hard surface cleaning composition may be diluted to a level of from 0.4% to 0.6% by volume, especially where the hard surface cleaning composition has a total surfactant level of greater than or equal to 5% by weight. Where the hard surface cleaning composition has a total surfactant level of less than 5% by weight, the hard surface cleaning composition may be diluted to a level of from 0.7% to 1.4% by volume. In preferred embodiments, the hard surface cleaning composition is diluted with water.

The dilution level is expressed as a percent defined as the fraction of the hard surface cleaning composition, by volume, with respect to the total amount of the diluted composition. For example, a dilution level of 5% by volume is equivalent to 50 ml of the hard surface cleaning composition being diluted to form 1000 ml of diluted composition.

The diluted composition can be applied by any suitable means, including using a mop, sponge, cloth, or other suitable implement.

Alternatively, the hard surface cleaning composition can be a “ready-to-use” composition, where dilution is not necessary. Such ready-to-use compositions can be comprised in a spray container.

In addition, for particularly dirty or greasy spots, or spots which have been contacted by microbes, the hard surface cleaning compositions, can be applied neat to the hard surface. When amine oxide and a further non-ionic surfactant is present, the composition provides improves penetration and removal of the stain, and especially of greasy stains, leading to improved surfactancy action and stain removal, as well as improved hygiene.

By “neat”, it is to be understood that the liquid composition is applied directly onto the surface to be treated without undergoing any significant dilution, i.e., the liquid composition herein is applied onto the hard surface as described herein, either directly or via an implement such as a sponge, without first diluting the composition. By “without undergoing any significant dilution”, what is meant is that the composition is diluted by less than 10 wt %, preferably less than 5 wt %, more preferably less than 3 wt %. Such dilutions can arise from the use of damp implements to apply the composition to the hard surface, such as sponges which have been “squeezed” dry.

In another preferred embodiment of the present invention said method of cleaning a hard surface includes the steps of applying, preferably spraying, said liquid composition onto said hard surface, leaving said liquid composition to act onto said surface for a period of time to allow said composition to act, with or without applying mechanical action.

### Methods:

### A) pH Measurement:

The pH is measured on the neat composition, at 25° C., using a pH meter with compatible gel-filled pH probe (such as Sartarius PT-10P meter with Toledo probe part number 52 000 100), calibrated according to the instructions manual.

### B) Shine:

Experiments to evaluate surface residues (i.e. shine performance) of the hard surface cleaning compositions were conducted using the following procedure. A clean, dry, glossy, black ceramic tile (20 cm×30 cm) was used as a representative hard surface. 0.5 mL of the ready-to-use composition was applied diagonally across the tile surface from bottom left to top right to create a continuous liquid deposit on the tile. The liquid deposit was then wiped across the tile using a damp cotton cloth (8 cm×10 cm folded into quarters) using a pattern of ×8 wipes horizontally (back and forth), ×10 wipes vertically (up and down) and ×8 wipes horizontally (back and forth). This wiping regime was conducted in a single continuous motion without lifting the cloth from the tile. The tile was then allowed to dry for 20 minutes. Panelists were then asked to grade the severity of residues on the tile according to the following scale:

0=No streaks

1=Very slight streaks

2=Slight streaks

3=Slight to moderate streaks

4=Moderate streaks

5=Moderate to heavy streaks

6=Heavy streaks

At least 8 panelists evaluated each tile. Mean streak gradings were compared using Dunnett's statistical test with nil solvent as the control, unless specified otherwise.

### EXAMPLES

Examples of ready-to-use compositions of the present invention are shown in Table 1. The compositions were made by mixing the components together, either as ready-to-use concentrations directly, or by first preparing a concentrated composition and then diluting in de-ionized water, such as a 1:10 dilution, to achieve the ready-to-use composition. The concentration of each component in a given composition corresponds to the weight of the component, provided on an active basis, as a percent of the total weight composition. The hydrogen peroxide is preferably added last to avoid any unintentional chemical reaction.

TABLE 1
Example ready-to-use composition (active weight %)

| | Ex. 1 | Ex. 2 | Ex. 3 | Ex. 4 | Ex. 5 | Ex. 6 | Ex. 7 |
|---|---|---|---|---|---|---|---|
| Sodium octyl | 0.15 | 0.15 | 0.15 | 0.6 | 0.6 | 0.15 | 0.15 |
| sulfate | | | | | | | |
| Succinic acid | 0.20 | 0.20 | 0.20 | 0.5 | 0.5 | 0.20 | 0.20 |
| Octanoic acid | 0.16 | 0.16 | 0.16 | — | — | 0.16 | 0.16 |
| Sodium hydroxide | 0.1 | 0.1 | 0.1 | — | 0.1 | 0.1 | 0.1 |
| Hydrogen peroxide | 0.5 | 0.5 | 0.5 | 0.45 | 0.45 | 0.5 | 0.5 |
| Decyl dimethyl | — | — | — | — | — | 0.5 | — |
| amine oxide | | | | | | | |
| Poly (2-ethyl- | — | — | 0.5 | — | — | — | — |
| 2-oxazoline) | | | | | | | |
| Propylene glycol | 0.5 | — | 0.5 | — | — | 0.5 | 2.0 |
| 1,3 Butylene glycol | — | 0.5 | — | 2.0 | 2.0 | — | — |
| Deionized water | to | to | to | to | to | to | to |
| | 100 | 100 | 100 | 100 | 100 | 100 | 100 |

Table 2 shows the shine performance of a composition based on 0.15% sodium octyl sulfate, 0.2% succinic acid, 0.16% octanoic acid, 0.1% sodium hydroxide and 0.5% hydrogen peroxide, with the addition of 2% by weight glycol solvent (propylene glycol) in comparison to a nil solvent control:

TABLE 2
Shine performance

| Solvent addition (2%) | Mean streak grade | Difference |
|---|---|---|
| Nil solvent (control) | 5.1 | (ref) |
| Propylene glycol | 3.3 | −1.8 |

Table 3 shows further examples of compositions of the present invention, made by mixing the ingredients together:

TABLE 3
Example ready-to-use composition (active weight %)

| | Ex. | Ex. | Ex. | Ex. | Ex. | Ex. | Ex. |
|---|---|---|---|---|---|---|---|
| | 8 | 9 | 10 | 11 | 12 | 13 | 14 |
| Sodium dodecylben- | 0.5 | — | — | — | 0.5 | 0.6 | — |
| zenesulfonate | | | | | | | |
| Sodium lauryl | — | 0.2 | — | — | — | — | — |
| sulfate | | | | | | | |
| Linear alkyl benezene | — | — | 0.9 | 0.5 | — | — | — |
| sulfonate | | | | | | | |
| C9-11 alcohol with | — | — | 0.9 | — | — | — | 1.0 |
| 8 ethoxylates | | | | | | | |
| Lactic acid | 0.2 | — | 0.8 | — | — | — | 0.6 |
| Citric acid | — | — | — | 0.5 | — | — | — |
| Succinic acid | — | — | — | — | — | 0.5 | — |
| Hydrogen peroxide | 0.4 | 0.4 | 0.8 | 0.5 | 0.5 | 0.5 | 0.5 |
| Propylene glycol | 0.5 | 0.5 | 0.5 | — | 0.5 | 0.5 | 0.5 |
| 1,3 butanediol | — | — | — | 0.5 | — | — | — |
| Deionized water | to | to | to | to | to | to | to |
| | 100 | 100 | 100 | 100 | 100 | 100 | 100 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “ 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hard surface cleaning composition comprising:
a. a detersive surfactant;
b. an active oxygen source;
c. a glycol solvent, wherein the glycol solvent is selected from the group consisting of C₁-C₆ diols and triols, and mixtures thereof;
d. water; and
said composition has a pH from about 1.0 to about 6.0.

2. The composition according to claim 1, wherein the glycol solvent is selected from the group consisting of propylene glycol, dipropylene glycol, glycerin, 1,3 butylene glycol, ethylene glycol, diethylene glycol, triethylene glycol and mixtures thereof.

3. The composition according to claim 1, wherein the glycol solvent is present at a level of from 0.01% to 10%.

4. The composition according to claim 1, wherein the glycol solvent is present at a level of from 0.1% to 1.0%.

5. The composition according to claim 1, wherein the active oxygen source is selected from the group consisting of: hydrogen peroxide, peroxyacids, organic peroxides and mixtures thereof.

6. The composition according to claim 5, wherein the active oxygen source is hydrogen peroxide.

7. The composition according to claim 1, wherein the active oxygen source is present at a level of from about 0.05% to about 8% by weight of the composition.

8. The composition according to claim 1, wherein the detersive surfactant is present at a level of from about 0.01% to about 20% by weight of the composition.

9. The composition according to claim 8, wherein the detersive surfactant is present at a level of from about 0.03% to about 10% by weight of the composition.

10. The composition according to claim 1, wherein the detersive surfactant comprises from 6 to 12 carbon atoms in the primary carbon chain.

11. The composition according to claim 1, wherein the composition further comprises amine oxide surfactant at a level of from about 0.01% to about 9.5% by weight of the composition.

12. The composition according to claim 11, wherein the composition further comprises amine oxide surfactant at a level of from about 0.01% to about 2.0% by weight of the composition.

13. The composition according to claim 1, wherein the acidifying agent is selected from the group consisting of: organic acid, inorganic acid, and mixtures thereof.

14. The composition according to claim 1, wherein the composition further comprises a polymer selected from the group consisting of: oxazoline homopolymer, oxazoline, copolymer, vinylpyrrolidone homopolymer (PVP); polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer;
and mixtures thereof.

15. The composition according to claim 10, wherein the composition comprises the polymer at a level of from about 0.005% to about 5.0% by weight of the total composition of the polymer.

16. The composition according to claim 15, wherein the composition comprises the polymer at a level of from about 0.2% to about 2.0% by weight of the total composition of the polymer.

17. A method for cleaning a hard surface, comprising the steps of:
a. optionally diluting the hard surface cleaning composition according to claim 1;
b. applying the hard surface cleaning composition to a hard surface;
c. leaving the hard surface to dry without rinsing the surface.
